(19) United States
(12) Patent Application Publication
(10) Pub. No.: US 2017/0287010 A1
(43) Pub. Date: Oct. 5, 2017

(54) ENHANCED MOBILE DEVICE BEACON SYSTEM

(71) Applicant: Bulzi Media Inc., Newport Beach, CA (US)

(72) Inventors: Brent Thomas McKay, Newport Beach, CA (US); Dale Hartzell, Boulder, CO (US); Roger Boehringer, Newport Beach, CA (US); Paul Smietan, Blue Jay, CA (US); Michael Perri, Centennial, CO (US); Steve Hillig, Anaheim, CA (US)

(21) Appl. No.: 15/478,535

(22) Filed: Apr. 4, 2017

Related U.S. Application Data
(60) Provisional application No. 62/390,557, filed on Apr. 4, 2016.

(51) Int. Cl. G06Q 30/02; G06F 17/30

(52) U.S. Cl. CPC G06Q 30/0267; G06F 17/30867; G06F 17/30377; G06Q 30/0261; G06Q 30/0269

(57) ABSTRACT

An enhanced beacon system that detects attributes of a user based on information obtained from or about a user device when the user device is in close proximity to a beacon device. Actions include receiving a first unique identifier of the user device and the user's information collected the beacon device. The user information can include at least attributes associated with physical movements of the user. The user information can be used to populate a user profile for the user. A campaign can be estimated for the user and transmitted to the user device based on at least partly on a calculation of attributes from the user information in the user profile and target criteria of the campaign.

### CROSS-REFERENCE TO RELATED APPLICATIONS

This application claims the benefit under 35 U.S.C. §119 of U.S. Provisional Patent Application No. 62/390,557, filed Apr. 4, 2016 (entitled “ENHANCED MOBILE DEVICE BEACON SYSTEM”). Any and all applications for which a foreign or domestic priority claim is identified in the Application Data Sheet as filed with the present application are hereby incorporated by reference in their entirety under 37 CFR 1.57.

### BACKGROUND

Mobile devices have become more ubiquitous and increasingly more location-aware. In general, there are two basic ways to identify the location of a mobile device: 1) the device self-reports its location through a network to a server based on one of several location technologies or methods, 2) the device is identified to be in proximity to a suitably equipped sensor. Beacons representative of current beacon products are systems which operate by emitting a unique identifier, typically using Bluetooth standards for communications, which can then be recognized by most smart phones with the appropriate hardware and software installed. Once the beacon identifier is captured by the phone it can do a look-up of that code through the cellular data connection to determine what other information is associated with it. The systems can then transmit contents to the smart phones. These systems do not collect personal information of the users of the computing devices, and accordingly, do not transmit targeted contents to the smart phones.

### SUMMARY

This disclosure relates to beacon technology which include sensing user computing devices and broadcasting the beacon's wireless signals to the mobile devices. The present disclosure provides improved beacon technology by providing improvements in consumer data collection and use within advertising systems. The present disclosure describes a beacon capable of collecting user information and/or unique identifiers of a user device. Based on the unique identifiers, a user profile can be created for the user to store the user information. The unique identifiers can be mapped with an anonymized identifier for the user. The user's profile, which is associated with the anonymized identifier, can be updated each time the user device is connected to the beacon system. In some embodiments, this can be achieved by the beacon system without recognizing the identity of the user. The beacon system can recognize the unique identifiers of a user device and associate them with the anonymized identifier and update the user information in the user profile. Based on computations of attributes of the user information, the content management system can transmit targeted campaigns to the user's device, wherein the targeted campaigns and their parameters are stored in a campaign database. The beacon system can further display the targeted campaigns on one or more display devices when a user is in proximity to the display device.

In one embodiment, an enhanced beacon system is disclosed, where the enhanced beacon system can detects attributes of a user based on information obtained from or about a user device, the enhanced beacon system comprising: a data store including one or more databases and one or more computer storage media, the data store including a first database configured to store user information of a plurality of users; and a second database configured to store campaign information of a plurality of campaigns; and a server configured to communicate with a beacon device, wherein the beacon device establishes a connection with the user device, wherein the user device being within a threshold distance of the beacon device; retrieves a first unique identifier of the user device, wherein the unique identifier are associated with the user; and continuously collects user information associated with the user from the user device; receive the user information and the first identifier from the beacon device, wherein the user information populating a user profile associated with the user in the first database; determine a first campaign of interest for the user based at least partly on the user information and target criteria of the first campaign, wherein the first campaign and the target criteria of the first campaign are stored in the second database; and provide the user with the first campaign. The enhanced beacon system, wherein the server is further configured to: transmit the first campaign to the user device, receive an outcome from the user device regarding the first campaign, store the first outcome as part of the user information in the user profile and as part of campaign information in the campaign database, refine the first campaign based at least partly on the outcome, and update the refined first campaign in the second database; display the first campaign on a display device, wherein the display device is in close proximity to the user device; transmit the first campaign to the display device via the beacon device; estimate a second campaign of interest for the user based at least partly on the user information and target criteria of the second campaign, wherein the second campaign and the target criteria of the second campaign are stored in the second database; determine an order of priority of the first campaign and the second campaign to be provided to the user based on one or more decision rules; provide the user with the first campaign and the second campaign based on the determined order of priority; assign an anonymized identifier to the user profile and map the first unique identifier with the anonymized identifier; receive a second unique identifier of the user device, wherein the second unique identifier is retrieved by the beacon device; map the first unique identifier and the second identifier based at least partly on their associations with the user device, wherein the user information includes at least attributes associated with physical movements of the user, and wherein the user information further includes demographic information, psychographic information, location information, distance information or any other personal information associated with the user.

In one embodiment, an database processing method executed on a server to retrieve and store data in one or more databases which detects attributes for a user based on information obtained from or about a user device is disclosed, the database processing method comprising: storing user information of a plurality of users in a first database; storing campaign information of a plurality of campaigns in a second database; communicating with a beacon device, wherein the beacon device establishes a connection with the user device, wherein the user device is within a threshold distance of the beacon device; retrieves a first unique identifier of the user device, wherein the unique identifier is associated with the user; and continuously collects user information associated with the user from the user device; receiving the user information and the first identifier from the beacon device, wherein the user information populating a user profile associated with the user in the first database; estimating a first campaign of interest for the user based at least partly on the user information and target criteria of the first campaign, wherein the first campaign and the target criteria of the first campaign are stored in the second database; and providing the user with the first campaign. The database processing method further comprising: transmitting the first campaign to the user device, receiving an outcome from the user device regarding the first campaign, storing the first outcome as part of the user information in the user profile and as part of campaign information in the campaign database, refining the first campaign based at least partly on the outcome, and updating the refined first campaign in the second database; displaying the first campaign on a display device, wherein the display device is in close proximity to the user device, wherein the display device receives the first campaign via the beacon device; estimating a second campaign of interest for the user based at least party on the user information and target criteria of the second campaign, wherein the second campaign and the target criteria of the second campaign are stored in the second database; determining an order of priority of the first campaign and the second campaign to be provided to the user based on one or more decision rules; providing the user with the first campaign and the second campaign based on the determined order of priority; assigning an anonymized identifier to the user profile and map the first unique identifier with the anonymized identifier; retrieving from the beacon device a second unique identifier of the user device, wherein the second unique identifier is retrieved by the beacon device; mapping the first unique identifier and the second identifier based at least partly on their associations with the user device, wherein the user information includes at least attributes associated with physical movements of the user and wherein the attributes associated with physical movements contain no personal identifiable information, the user information including demographic information, psychographic information, location information, distance information or any other personal information associated with the user.

In one embodiment, a beacon device which detects attributes of a user based on information obtained from or about a user device, wherein the beacon device is configured to: establish a connection with the user device, wherein the user device being within a threshold distance of the beacon device; retrieve a first unique identifier of the user device, wherein the first unique identifier is associated with the user; continuously collect user information associated with the user from the user device, the user information populating a user profile associated with the user in a first database; and transmit the collected user information and the first unique identifier to a server; receive a first campaign of interest for the user, wherein the first campaign is estimated by the server based at least partly on the user information and target criteria of the first campaign, wherein the first campaign and the target criteria of the first campaign are stored in a second database; and provide the user with the first campaign. The beacon device is further configured to: transmit the first campaign to the user device. receive an outcome from the user device regarding the first campaign, and transmit the first outcome to the server, wherein the first outcome to be stored as part of the user information in the user profile and as part of campaign information in the campaign database, and to be used to refine the first campaign; transmit the first campaign to a display device, wherein the display device is in close proximity to the user device; receive from the server a second campaign of interest for the user, wherein the second campaign is estimated based at least partly on the user information and target criteria of the second campaign, wherein the second campaign and the target criteria of the second campaign are stored in the second database; provide the user with the first campaign and the second campaign based on an order of priority, wherein the order of priority is determined based on one or more decision rules; receive a second unique identifier of the user device; transmit the second unique identifier to the server. The first unique identifier and the second unique identifier are mapped with an anonymized identifier assigned to the user profile, wherein the user information includes at least at least attributes associated with physical movements of the user, wherein the attributes associated with the physical movements of the user contain no personal identifiable information, and wherein the user information further includes demographic information, psychographic information, location information, distance information or any other personal information associated with the user.

### BRIEF DESCRIPTION OF THE DRAWINGS

FIG. 1 illustrates an example computing environment of the enhanced mobile device beacon system according to one embodiment of the present disclosure.

FIG. 2 illustrates an example of determining content to be sent to user devices in a beacon engagement session via the enhanced mobile device beacon system.

FIG. 3 illustrates a process flow diagram of an example of a method for transmitting content to a user device via the enhanced mobile device beacon system.

FIG. 4 illustrates a process flow diagram of an example of a method for identifying a user via the enhanced mobile device beacon system.

FIG. 5 illustrates a process flow diagram of an example of a method for mapping identifiers of a user device.

FIG. 6 illustrates an example of determining content to be sent to user devices in multiple beacon sessions via the enhanced mobile device beacon system.

FIG. 7 illustrates a process flow diagram of an example of a method for determining content to be sent to user devices in multiple beacon sessions via the enhanced mobile device beacon system.

FIG. 8 illustrates another example of computing environment of the enhanced mobile device beacon system.

FIG. 9 illustrates an example of determining content to be displayed to users via the enhanced mobile device beacon system.

FIG. 10 illustrates a process flow diagram of an example of determining content to be displayed to users via the enhanced mobile device beacon system.

FIG. 11 illustrates an example of interaction between user devices and multiple beacon sessions via the enhanced mobile device beacon system.

FIG. 12 illustrates and process flow diagram of an example of interaction between user devices and multiple beacon sessions via the enhanced mobile device beacon system.

### DETAILED DESCRIPTION

The enhanced mobile device beacon system (“the system”) can identify and/or communicate with user devices such as smartphones, tablets and other devices when the user devices are in close proximity to a beacon device. The system can have a number of applications. For example, and not by way of limitation, the system can be useful in an advertising or campaign setting. Such applications can include, but are not limited to, determination of a user device's physical location, tracking customers, collecting user information, triggering a location-based action, offering customers targeted campaigns and enabling mobile payments. The present disclosure can collect user information and unique identifiers of a user device via a beacon system. Based on the unique identifiers, a user profile can be created for the user to store the user information. The unique identifiers can be mapped with an anonymized identifier for the user. The user's profile, which is associated with the anonymized identifier, can be updated each time the user device is connected to the beacon system. The beacon system can recognize the unique identifiers of a user device and associate them with the anonymized identifier and update the user information in the user profile. Based on computations of attributes in the user information, the system can transmit targeted campaigns to the user's device, wherein the targeted campaigns and their parameters are stored in a campaign database. The beacon system can further display the targeted campaigns on one or more display devices when a user is in proximity to the display device.

### Example Mobile Device Beacon System

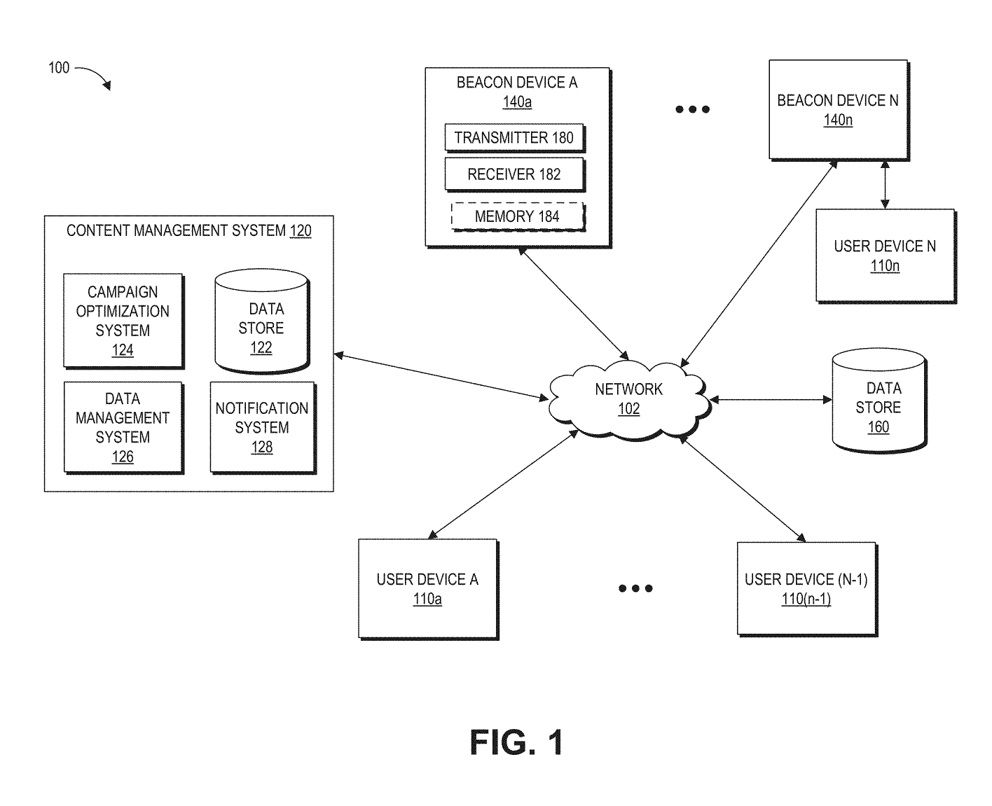

FIG. 1 illustrates an example computing environment 100 in which one or more beacon devices can interact with one or more user devices via the system. The example computing environment 100 in FIG. 1 includes beacon device A 140a through beacon device N 140n, user device A 110a through user device N 110n, a remote data store 160, and a content management system 120. The beacon devices, the user devices and the content management system 120 can communicate with each other using a network 102. In some embodiments, the content management system 120 can provide a centralized campaign database for users of the system. The computing environment 100 can allow system users, to input, edit, organize, and compute data in the content management system 120 via a computing device. Additionally, the content management system 120 can be connected to the data store 160 via the network 102. In one example, the data store 160 is a cloud-based data store. The content management system 120 can store, access or update data in the data store 160. In some embodiments, the computing environment 100 can use the data store 160 as a backup data store for the content management system 120. Further, the computing environment 100 can also use the data store 160 as a primary data store for the content management system 120.

In some embodiments, there can be multiple content management systems 120 in the computing environment 100. The multiple content management systems 120 can belong to one or more entities. The entities can be retailers, advertisement agencies, etc. The entities can have different objectives in using the multiple content management systems. Each content management system 120 can serve a different objective. For example, one entity in the computing environment may wish to deliver promotional campaigns to the user device A 110a while another entity may wish to collect user data for later analysis. In some embodiments, there can be one centralized content management system 120 for all entities. Entities, who wish to use the system, can utilize the centralized content management system 120 to input, edit, organize, and compute user data. Additionally, the content management system 120 can be incorporated in a beacon device.

The network 102 can be a local area network, a wide area network, a peer-to-peer network, radio frequency, Bluetooth, Wi-Fi, or any other type of communication network. In some embodiments, components within the computing environment 100 can communicate with each other through different types of networks. For example, the beacon device A 140a can communicate with the user device A 110a via Bluetooth while the beacon device A 140a can also communicate with the content management system 120 via a local area network. As another example, the content management system 120 can communicate with the data store 160 via a wide area network while the content management system 120 can communicate with the beacon device N 140n via a local area network. Additionally, the beacon devices can communicate with the user devices directly via a local wireless technology.

Examples of a Content Management System

The content management system 120 can perform various functions in the computing environment, such as collecting data associated with user information, storing campaigns or other contents, transmitting targeted campaigns to users, computing outcomes of campaigns, predicting user behaviors, etc. The content management system 120 can be a part of one or more servers. The content management system 120 can contain multiple sub-systems performing various functions. In the example of FIG. 1, the content management system 120 includes a campaign optimization system 124, a data management system 126, a notification system 128, and a data store 122. The data store 122 can be a local data store. Alternatively, the data store 122 can be a remote data store connected to the content management system 120 via the network 102. In some embodiments, one or more sub-systems can perform one or more functions as illustrated below. The content management system 120 can be connected to the user device A 110a directly or through the beacon device A 140a. In some embodiments, the content management system 120 can communicate with the user device A 110a directly or through the beacon device A 140a.

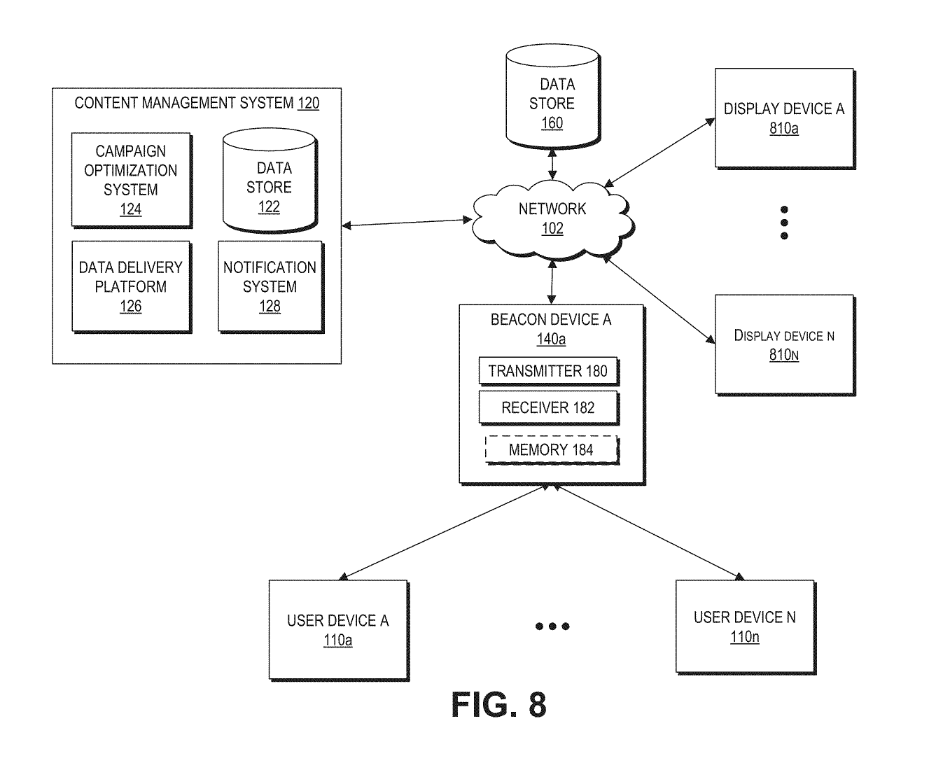

The data management system 126 can communicate, exchange, or share data with other devices or systems, such as beacon devices, user devices, the remoted data store 160, a third party data system, etc. The data management system 126 can collect user information, update user profiles, map unique identifiers with anonymized identifiers, store campaign information, etc. The campaign optimization system 124 can determine one or more campaigns to be sent to a user device based on computations of data stored in the data management system 126. The campaign optimization system 124 can also determine one or more campaigns to be displayed on a display device. The display device can be connected to the system and can be in a close proximity to the user as later described in detail with reference to FIG. 8. The campaign optimization system 124 can also determine which user devices the one or more campaigns to be sent to or to be displayed. The campaign optimization system 124 can make the determination based on one or more decision rules. One or more system users can define the decision rules. The notification system 128 can transmit data to the user devices and the beacon devices. The notification system 128 can make a determination regarding a notification to be sent to a user device based on one or more decision rules. The determination can include information regarding what the notification should contain, when the system should transmit the notification to the user device, etc. During a beacon engagement session, the notification system 128 can update the determination based on updates in the campaign optimization system 124 or the data management system 126. The notification can be can be an advertisement campaign, a video, an audio, a message, a map, etc. The notification can include a directional indicator, a distance indicator, and a category type indicator or some combination in a map to be displayed on a user device. The category type indicator can be a store or product or advertising display. In some embodiments, this can be achieved by an application installed on the user device A 110a. The application can allow the user to see where the beacon device A 140a is in relation to the user device A 110a, and the distance between the beacon device A 140a and the user device A 110a. The system can instruct the application to point the directional indicator at the direction of the beacon device. The system can, via the application, function as an indoor map to allow the user to use their device to get a direction of a target object and a distance between the user device and the target object.

For example, after the beacon device A 140a has detected one or more user devices in a beacon engagement session and has retrieved unique identifiers associated with the user devices, the beacon system can transmit the retrieved unique identifiers to the content management system 120. In some embodiments, the content management system 120 can retrieve the unique identifiers from the user devices directly. The content management system 120 can retrieve one or more anonymized identifiers associated with the unique identifiers. The data management system 126 can then identify one or more user profiles associated with the anonymized identifiers and update collected user information in the user profiles. In some embodiments, the one or more criteria can be applied by the campaign optimization system 124 to the user information in the identified user profiles.

In some embodiments, upon identifying the user profiles associated with the user devices near the beacon device A 140a, the campaign optimization system 124 can analyze the attributes associated with the user profiles. The campaign optimization system 124 can then, based on the analysis, determine one or more targeted campaigns the system should transmit to the user devices. The campaign optimization system 124 can also determine one or more campaigns to be displayed on a display device. The display device can be connected to the system and can be in a close proximity to the user as later described in detail with reference to FIG. 8. In some embodiments, the system can communicate with a third-party system, which can include one or more campaign databases, to determine one or more campaigns from the third-party system the beacon system can transmit to the user devices.

The system, in some embodiments, can provide a graphic user interface to the system users to access the content management system 120. The system users can upload a campaign to the content management system 120. The campaign can include campaign information in the campaign such as campaign contents, campaign objectives, campaign parameters, target audiences, campaign bids, product information, etc. The campaign profile can also include any other type information associated with a campaign. For example, a beer manufacturer may want to promote its newly launched light beer and it may only want to send advertisements to potential customers over 21 years old. The content management system 120 can store the campaign in a campaign database. The campaign can be an advertisement, a video, an audio, a message, a map, etc. The campaign can also be a notification. A campaign can be uploaded for different purposes, such as commercial purposes, aesthetic purposes, charitable purposes, etc.

In some embodiments, the content management system 120 can communicate with a remote data store 160. The remote data store 160 can be a third-party data store such as an advertisement agency database. The content management system 120 can access data in the remote data store 160. The content management system 120, in some cases, can retrieve data from the remote data store 160 and store the data in the data store 122. In some cases, the remote data store 160 can function as a backup data store for the data store 122.

Example Data Management System

In the example of FIG.1, the content management system 120 includes a data management system 126. The data management system 126 can communicate, exchange, or share data with other devices or systems, such as beacon devices A 140a through N 140n, user devices 110a to 110n, the remote data store 160, a third party data system, etc. For example, the data management system 126 can receive user information collected by the beacon devices. As another example, the data management system 126 can communicate with various advertising systems. The data management system 126 can also communicate with a live data source. For example, the data management system 126 can be connected to one or more live TV streams. The data management system 126 can then transmit data it receives from the one or more live streams to the user devices 110a to 110n. The transmitted data can include an identifier of the live streams. The identifier of the live streams can include a channel, a website, etc.

The data management system 126 can store various information in one or more databases, such as user information, campaign information, outcome information etc. The data management system 126 can receive user information from various beacon devices A 140a to N 140n as the beacon devices collect the user information from various devices 110a to 110n. The user information can also be provided to the data management system 126 as the system communicates with other devices or systems.

The data management system 126 can create a user profile for each user. The user profile can contain various information associated with the user. The user information can include attributes that can be used to identify the user. The user information can also include non-identifying attributes, such as location attributes. The non-identifying attributes do not include information regarding the user as later described in detail with reference to FIG. 8. The user information can include unique identifiers of user devices associated with the user. The unique identifiers can include unique wireless signatures broadcast by the device and visible to suitable hardware sensors locating in proximity (“LAN” identifiers) such as, MAC address, Bluetooth IDs, carrier identifiers, custom wireless signatures, etc. The unique identifiers can also include software identifiers (“WAN” identifiers), such cookies, persistent cookie ID, ID for Ad, Google Ad ID, email addresses, social network IDs, etc., which are transmitted by the device over the wireless carrier network. The user profile can contain unique identifiers of various user devices associated with the same user. For example, the user profile can contain a first unique identifier associated with the user's iPhone, a second unique identifier associated with the user's smartphone, etc. As a result, the user can be associated with one or more unique identifiers. The data management system 126 can then store the user information associated with the one or more unique identifiers in the user's profile. Furthermore, the data management system 126 can assign an anonymized identifier to the user profile. The unique identifiers of the user devices associated with the same user can be mapped with the anonymized identifier.

Additionally, the user profile can also include personal information associated with the user, such as demographic information, psychographic information, location information, distance information etc. The demographic information can include information about one or more users of the user device, such as age, income, address, race, household information, etc. The psychographic information can include information stored on the user device about the one or more users' interest, lifestyle, etc. The location information can include current location information, past location information and future location information. The future location information can be determined based on the browsing history stored in the user device. The distance information can include a distance between the user device and a beacon device at a certain time. The distance information can be determined by collecting the GPS data, triangulation between multiple beacons, or any other location data from the user devices or other location indicators. In some embodiments, location data from multiple user devices can be collected via the beacon devices 140a through 140n and analyzed according to the estimated accuracy of each location data reported by each user device, as well as other clustering analytics processes, in order to continuously refine the estimated distance between and/or relative location of the user devices and beacon devices 140a through 140n.

Upon receiving user information from the user device 110a, the data management system 126 can look for a unique identifier associated with the user information, and an anonymized identifier associated with the unique identifier. The data management system 126 can then update the user information in a user profile that is associated with the anonymized identifier. If there is no anonymized identifier associated with the unique identifier, the data management system 126 can then analyze the collected user information and determine whether there is an existing user profile associated with the user information. If there is, the data management system 126 can map the unique identifier with the anonymized identifier associated with the user profile. If there is not, the data management system 126 can create a new user profile and a new anonymized identifier associated with the new user profile. The data management system 126 can then store the user information in the new user profile and map the new anonymized identifier with the unique identifier. In some embodiments, the user profile can also contain household information. The data management system 126 can also create a household profile. The household profile can contain one or more user profiles. The one or more user profiles in the same household can share one anonymized identifier. Alternatively, the data management content system 126 can assign an anonymized identifier to unique identifiers associated with a user without creating a user profile. The user information associated with the unique identifiers and the unique identifiers can be stored in the system.

Additionally, by mapping an anonymized identifier with the unique identifiers associated with the user, the data management system 126 can map the LAN identifiers with the WAN identifiers. In some embodiments, the data management system 126 can determine whether the LAN identifiers do not match the WAN identifiers based on the collected user information and the user profile. If the data management system 126 determines that a newly collected LAN identifier does not match the WAN identifiers, the data management system 126 can associate a probability that the LAN identifier corresponds to the WAN identifiers. The probability can be used by the campaign optimization system 124 in determining targeted campaigns.

In some embodiments, if the data management system 126 determines that a newly collected LAN identifier does not match the WAN identifiers, the data management system 126 can analyze the collected user information associated with the LAN identifier and determine whether there is a user profile associated with the LAN identifier in the user database. If there is, the data management system 126 can store the collected user information to the user profile. If there is no user profile associated with the LAN identifier, the data management system 126 can create a new user profile and a new anonymized identifier associated with the new user profile.

The data management system 126 can also store campaigns in a campaign database. The data management system 126 can create a campaign profile for each campaign or each entity. The campaign profile can include campaign contents, campaign objectives, campaign parameters, target audiences, campaign bids, etc. The campaign profile can further contain target criteria for one or more campaigns. The target criteria can be defined by a system user. The target criteria can indicate a target audience of a campaign, such as an age range, a geographic area, an interest, etc. For example, a bike campaign can target people who have searched bikes recently. As another example, a gym campaign can target people who are within a 15 mile radius of the gym. In some embodiments, a campaign profile can specify one or more beacon devices that the system can transmit campaigns to the user device only if the system establishes connections with the user via the one or more specified beacon devices.

In some embodiments, to improve computing efficiency, the data management system 126 can group user profiles into various potential customer groups. The potential customer groups can contain anonymized identifiers associated with users meeting the same criteria. For example, the data management system 126 can create a potential user group containing anonymized identifiers associated with users over 18 years old. Similarly, the data management system 126 can group campaign profiles into various potential campaign groups. The potential campaign groups can only contain campaigns with the same or similar target criteria. The potential customer groups or the potential campaign groups can be used by the campaign optimization system 124 in determining targeted campaigns.

Example Campaign Optimization System

In the example of FIG. 1, the content management system 120 contains a campaign optimization system 124. The campaign optimization system 124 can determine one or more campaigns to be sent to a user device. The campaign optimization system 124 can also determine which user device(s) the one or more campaigns to be sent to. The campaign optimization system 124 can also determine one or more campaigns to be displayed on a display device. The display device can be connected to the system and can be in a close proximity to the user as later described in detail with reference to FIG. 8. The campaign optimization system 124 can make the determination based on one or more decision rules. One or more system users can define the decision rules.

The content management system 120 can contain a campaign database as described with reference to the data management system 126. The campaign database can contain data associated with campaign information about one or more campaigns. The campaign information can include campaign contents, campaign parameters, campaign objectives, target audiences, campaign bids, etc. In some embodiments, the campaign information can include one or more criteria for the target audience. The one or more criteria can be applied by the campaign optimization system 124 to determine which user devices the one or more campaigns to be sent to. The one or more criteria can also be applied by the campaign optimization system 124 to determine one or more display devices the one or more campaigns to be displayed on. The one or more display devices can be local display devise that in close proximity to the user.

The campaign optimization system 124 can compute attributes in a user profile based on the campaign criteria to determine one or more targeted campaigns. The one or more campaigns can be campaigns that the user is interested in. The one or more campaigns can also be campaigns that the system can receive a best outcome from the user. The attributes can be associated with various aspects of a user, including but not limited to, demographic attributes, psychographic attributes, location attributes. The demographic attributes can include age, income, address, race, household information, etc. The psychographic attributes can include interest, lifestyle, etc. The location attributes can include, physical movements, current location, past locations and future locations determined based on the browsing history stored in the user device. The attributes associated with the physical movements may include information regarding the movements of the user within a specific time period. As the examples described with reference to the content management system 120: a bike campaign can targeting people who have searched bikes (psychographic attributes); a gym campaign is targeting people who live in a 15 mile radius within the gym (demographic attributes). The attributes can also include any other user information, such as how the user reacted to a campaign previously delivered to the user's device in the last beacon engagement session, whether the user current owns a product related to one or more campaigns, how well the user reacts to campaigns in general, etc.

The campaign optimization system 124, in some embodiments, can determine the one or more campaigns based on non-personal identifiable attributes collected via the beacon device A 140a. For example, based on the location attributes associated with the user, the current location, past locations the user has been visited, the campaign optimization system 124 can determine the one or more targeted campaigns to be sent to the user device or to be displayed on one or more display devices. The targeted campaigns can be those campaigns that interest the user. This way, the system can make a campaign recommendation without knowing the identity of the user.

After the beacon device 140a has detected one or more user devices in a beacon engagement session and has retrieved unique identifiers associated with the user devices, the beacon system can transfer the unique identifiers to the content management system 120. In some embodiments, the content management system 120 can retrieve the unique identifiers from the user devices directly. The content management system 120 can retrieve one or more anonymized identifiers associated with the unique identifiers. The data management system 126 can then identify one or more user profiles associated with the anonymized identifiers. In some embodiments, the one or more criteria can be applied by the campaign optimization system to user information in the identified user profiles.

In some embodiments, upon identifying the user profiles associated with the user devices near the beacon device, the campaign optimization system 124 can analyze the attributes associated with the user profiles. The campaign optimization system 124 can then, based on the analysis, determine one or more campaigns the system can transmit to the user devices. In some embodiments, the system can communicate with a third-party system, which can include one or more campaign databases, to determine one or more campaigns from the third-party system the beacon system should transmit to the user devices.

As the beacon engagement session continues, in some embodiments, the content management system 120 can update user information based on newly collected user information in the beacon engagement session. The content management system 120, in some embodiments, can also compare newly collected user information with the user information in the user profile. The campaign optimization system 124 can then determine one or more updated campaigns the system should transmit to the user devices based on the updated information. For example, during one beacon engagement session, the system learns that a user started taking boxing classes based on the search histories. The system can adjust its computation based on the new information and send updated campaigns to the user's device.

During a beacon engagement session or a campaign flight, the system can monitor an outcome of a campaign. The outcome can include information about how long the user engages with the system in the session or the flight, whether the user reacts positively to a current or a previous campaign, etc. The system can store the outcome in the user database and the campaign database. In some embodiments, the system can communicate the outcome with a third-party system. The system can later use the outcome in later analysis.

The campaign optimization system 124 can also include a machine learning module. The machine learning module can use one or more machine learning algorithms. In some embodiments, the machine learning module can analyze a campaign based on one or more outcomes, user profiles or campaign profiles in the system. Also, as the machine learning module makes an analysis, the system can take transaction data or foot traffic data into consideration. The footfall data can be foot traffic changes in the beacon coverage area.

The campaign optimization system 124 can use the analysis to refine current or future campaigns. The refinement can include changes in campaign content, campaign timing, campaign criteria, etc. The campaign optimization system 124 can also make recommendations on how to refine future campaigns. For example, based on a negative outcome that a user does not react positively to a current campaign and the user's information in the user profile, the campaign optimization system 124 can make recommendations on how to improve the campaign to be more appealable to the user.

In some embodiments, the machine learning module can edit and update one or more current campaigns based on the analysis. The machine learning module can also refine one or more current campaigns based on the analysis. The machine learning module can run variants simultaneously and then select one or more high-performing campaigns to replace one or more underperforming campaigns during one or more beacon engagement sessions or campaign flights.

Example Notification System

In the example of FIG. 1, the content management system 120 includes a notification system 128. The notification system 128 can transmit data to the user devices and the beacon devices. The notification system 128 can make a determination regarding a notification to be sent to a user device based on one or more decision rules. The determination can include information regarding what the notification should contain, when the system should transmit the notification to the user device, etc. During a beacon engagement session, the notification system 128 can update the determination based on updates in the campaign optimization system 124 or the data management system 126. The notification can be can be an advertisement campaign, a video, an audio, a message, a map, etc. The notification can include a directional indicator, a distance indicator, and a category type indicator or some combination in a map to be displayed on a user device. The category type indicator can be a store or product or advertising display. In some embodiments, this can be achieved by an application installed in the user device A 110a. The application can allow the user to see where the beacon device A 140a is in relation to the user device A 110a, and the distance between the beacon device A 140a and the user device A 110a. The system can instruct the application to point the directional indicator at the direction of the beacon device. The system can, via the application, function as an indoor map to allow the user to use their device to get a direction of a target object and a distance between the user device and the target object.

During a beacon engagement session, if the campaign optimization system 124 determines a campaign to be sent to the user device or to be displayed on a display device, the notification system 128 can determine a notification to be sent to the user, etc. Alternatively, if the campaign optimization system 124 determines more than one campaign to be sent to the user device or to be displayed on the display device, the notification system 128 can determine one or more notifications to be sent to the users. If the notification system 128 determines to send the user device two or more notifications, the notification system 128 can also determine which notification the system should send to the user device first. The notification system 128 can also determine how to send the notifications to the user, include an order of the notifications. The notification system 128 can make the determinations based on one or more decision rules.

In some embodiments, a user device can communicate with two or more beacon devices. The beacon devices can belong to one or more enhanced beacon systems. If the beacon devices belong to more than one enhanced beacon system, in some embodiments, the enhanced beacon systems can communicate with each other and the notification systems can determine how to send notifications to the user device based on the one or more decision rules.

One or more system users can define various decision rules. The decision rules can determine an order of priority of the notifications the system(s) should send to user devices. In some embodiments, the notifications are prioritized or filtered in part according to the proximity of beacons to the user device at the time of the communications or sometime after or before the communications. The notifications can also be prioritized or filtered in part according to a payment from advertiser(s) or other third parties for premium placements. The notifications can also be prioritized or filtered in part according to the presence of the user device in a specific geographic area at the time of a beacon session or sometime after or before the session. The geographic area can be associated with a building perimeter or building perimeter plus additional surrounding area owned by the building owner, such as a parking lot perimeter. The notifications can also be prioritized or filtered in part according to the bids from advertisers or other third parties during an auction, whether the auction is real-time or not real-time in nature. The notifications can also be prioritized or filtered based in part on some combination of the above criteria. The notifications can also be prioritized or filtered as defined by a system user.

Examples of a Beacon Device

The beacon devices A-N can be any types of beacon devices. The beacon devices can be Accent beacon devices, Estimate beacon devices, etc. The beacon devices can work with any proximity technologies, such as iBeacon, Eddystone, Indoor Location, etc. The beacon device A 140a can include a transmitter unit 180, a receiver unit 182, and in some embodiments, an optional memory 184. The transmitter unit 180 and the receiver unit 182 can also be incorporated in one device. Alternatively, the transmitter unit 180 and the receiver unit 182 can also be incorporated in two devices and the two devices can be placed in different locations. In some embodiments, the beacon devices can also be any types of computing devices that can perform the functions of a transmitter unit and a receiver unit. The beacon device A 140a can be connected with one or more devices or systems via a wired or wireless connection. For example, the beacon device A 140a can be connected to a TV set via the TV set's USB port. In some embodiments, the beacon device A 140a may further include a GPS component to improve the accuracy of the system.

The transmitter unit 180 can broadcast signals to a user device A 110a over the air. The signals can be radio signals, a Uniform Resource Locator (“URL”), and any other signals that can contain unique, location-specific information or communicate with the user devices regarding information about locations. An example of the transmitter unit 180 is a Bluetooth Low Energy transmitter. The transmitter unit 180 can also transmit data from the content management system 120 to the user device A 110a. For example, the transmitter unit 180 can send a message to the user device A 110a. The transmitter unit 180 can transmit signals to a beacon engagement session coverage area. The beacon engagement session coverage area can be within a threshold distance of the beacon device A 140a where the beacon's signal has sufficient signal strength to be received. The threshold may depend on the make or type of the beacon device A 140a.

The receiver unit 182 can be any devices that can receive data transmitted from the user device A 110a. The beacon device A 140a can also transmit the received data to the content management system 120. Additionally, the beacon device A 140a can store the received data, in some embodiments, temporarily in the memory 184 before transmitting it to the content management system 120. The received data can include user information and unique identifiers.

The beacon device A 140a can be any type of computing device. Examples of a computing device are a smartphone, a computer, a laptop, a smartwatch, etc. In some cases, some computing devices can have hardware components performing the same functions as the transmitter unit and the receiver unit. In other cases, a computing device can function as a beacon device with the help of certain software or an external component. For example, a smartphone can transmit signals and receive data through its Bluetooth component. With certain software installed in the smartphone, the smartphone can function as a beacon device. For example, the smartphone using the software can send signals to other user devices in proximity. After establishing connections between the smartphone and the other devices, the system can collect information of the other devices, such as unique identifiers of the other devices and user information related to the other devices. In some embodiments, by converting a user device into a beacon device, the system can allow crowd-sourced data collection. The system can collect more user information associated with other user devices via the user device.

The beacon device A 140a can be placed in any locations. For example, it can be placed on the walls of her restaurant. The beacon device A 140a can then transmit signals to attract customers in the restaurant or people around the restaurant. As another example, the beacon device A 140a can be placed on a food truck. The beacon device can transmit signals to attract people around the truck. As another example, a politician can carry the beacon device A 140a in her briefcase as she gives speech to potential donors.

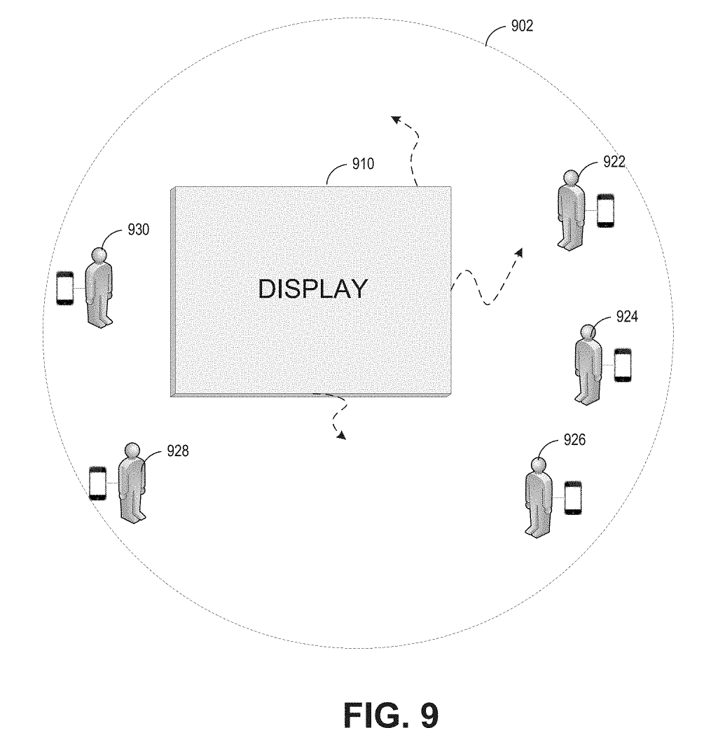

The beacon device A 140a can also be incorporated with any other devices. As later described with reference to FIGS. 9 to 12, the beacon device A 140a can be incorporated with a display device, such as a billboard, a TV, or the like. The display device can display contents determined by the content management system 120. As another example, the beacon device A 140a can be incorporated with a radio device. The radio device can then broadcast information to users. In some embodiments, the owner can also store data in the memory 184 of the beacon device A 140a. As the beacon device transmits signals, the system can instruct the transmitter unit 180 to present the data stored in the memory 184 to the user device A 140a.

In some embodiments, the beacon device A 140a can further include solar power capabilities. This can allow the beacon device to operate in a low-power environment without the use of AC power connections. This can eliminate the need to provision AC power where it was unavailable or costly to do so.

Examples of a User Device

A user device can be any type of computing devices that can capture signals or data transmitted from the beacon devices, such as a smartphone, a tablet, a laptop, a smartwatch, etc. Multiple user devices can be associated with one user. For example, a user can own a laptop, a smartphone, a tablet, etc. The user device A 110a can display contents received from the beacon device A 140a or the content management system 120. In some embodiments, the user device A 110a, upon receiving signals from the beacon device A 140a, can transmit data to the local receiver 182, the beacon device A 140a, or the content management system 120 in a beacon engagement session. The transmitted data can include unique identifiers of the user device A 110a and user information associated with the user device A 110a.

In some embodiments, the user device A 110a can launch certain software on the user device in response to an external stimulus, such as broadcasted signals by the beacon device A 140a. The external stimulus can be a signal, an incoming message, or a network connection transmitted from the beacon device A 140a, etc. Also, in response to an external stimulus, certain software can be loaded onto the user device A 110a. The software can retrieve and collect user information associated with the user device A 110a. This can be achieved via software installed on the user device A 110a or executed as a system function or application. For example, as the user device A 110a detects and captures a URL signal transmitted by the beacon device A 140a, the user device A 110a can load the captured URL onto a web browser. User interactions may not be necessary in this process as the user device A 110a can load the URL in the web browser in the background without any notifications to the user. The web browser cannot be visible to the user. The user device A 110a can then be connected to and can communicate with the content management system 120.

As it establishes connections with the user device A 110a and a beacon engagement session begins, the system can also instruct a web browser extension to be installed on the user device. The web browser extension, in some embodiments, can report user device location information to the system as a web browser is launched on the user device A 110a. Further, the system can instruct the user device A 110a to install certain interactive software. In some cases, the interactive software can offer no visible indicator to the user. In some cases, the interactive software can also launch a visible screen on the user device A 110a. The visible screen can display additional information to the user of the user device A 110a. The user can further interact with the system via the screen. In some cases, the interactive software can remain active in the background. The interactive software can keep collecting user information while running in the background. The interactive software can, in some embodiments, remind the user periodically to interact with the system as it is running in the background. In some embodiments, the interactive software can recognize audio commands from the user.

In some embodiments, the system can instruct the user device A 110a to close the interactive software upon a completion event. The completion event can be an instruction from the user or the content management system 120. The completion event can also be a determination that the user device A 110a is no longer within the engagement session coverage area of the beacon device A 140a. The completion event can also be defined in the content management system 120 by a system user or on the user device A 110a by the user.

The system can instruct the user device A 110a to disable or remove the interactive software upon a disable event. The disable event can be a determination that the user device A 110a is no longer within the coverage of the beacon device A 140a. The disable event can also be a determination by the content management system 120 that the user is not among a target audience.

The user device A 110a can also display the targeted campaigns determined by the campaign optimization system 124. This can be achieved by a system function of the user device A 110a or via the interactive software. The user can, via the user device A 110a, view the campaign in forms of video, audio, text, map, etc. The user can also share the targeted campaigns with others via one or more social networks.

### Examples of a Beacon Engagement Session

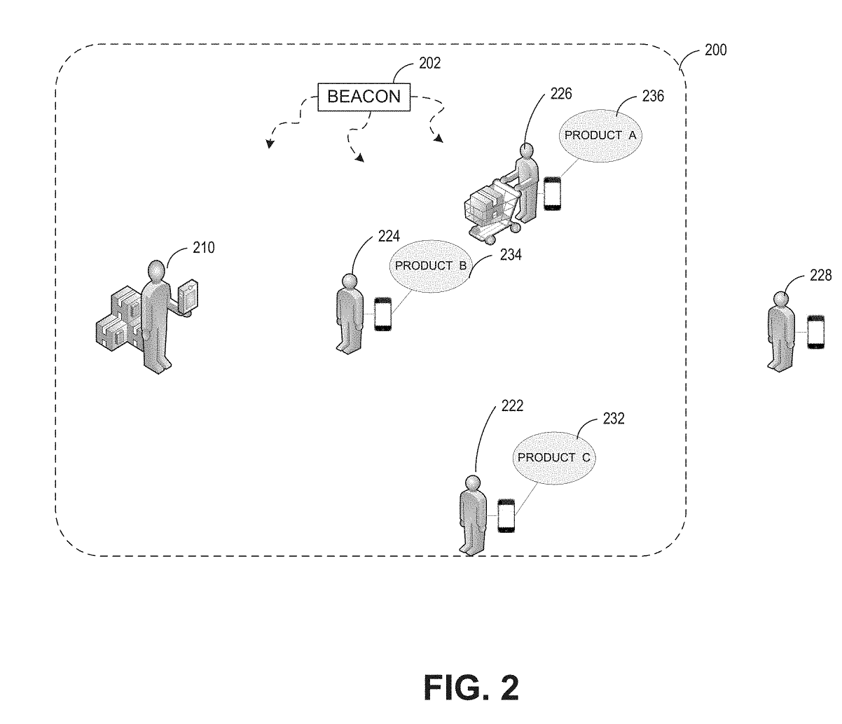

FIG. 2 illustrates an example of determining campaigns to be sent to user devices in a beacon engagement session via the enhanced mobile device beacon system. In the example of FIG. 2, the dotted box 200 is an engagement session coverage area of a beacon device 202. The beacon device 202 belongs to a system user 210. The system user 210 can be a vendor who is trying to sell products. Users 222, 224, 226 and 228 are each carrying one or more user devices. In some embodiments, the system user 210 can upload one or more campaign to the system. The system user 210 can also use campaigns uploaded by other system users. As the users 222, 224, 226 and 228 walk around, the beacon device 202 continuously transmits signals in an effect to communicate with the user devices. The user devices of the users 222, 224 and 226 can capture the signals as they are in a coverage area of the beacon signals. In contrast, the user device of the user 229 cannot capture any signals as it is outside of the coverage area.

Upon establishing connections between the beacon device 202 and the user devices of the users 222, 224, and 226, a beacon engagement session begins. The system can retrieve unique identifiers of the user devices, including LAN identifiers and WAN identifiers. The system can then collect attributes and user information associated with the user devices. The attributes can include measurements, beacon engagement, demographic metrics, etc. In some embodiments, the system can then assign or map one or more anonymized identifiers to the retrieved unique identifiers. Each unique identifier can be associated with a user profile in the user database. The system can then update the attributes in the user database.

The system can then determine one or more campaigns to be sent to the user devices. The determination can be at least partly based on a calculation of attributes of the user information in the user profile(s) in the user database associated with the user devices, campaign information in the campaign database, etc. Based on the determination, the system can then transmit one or more campaigns to the user devices. The campaigns can be advertisements uploaded by the system user 210 in order to promote products in his store. The campaigns can also be promotions uploaded by other system users. In some embodiments, the system can also display the one or more campaigns on a display device. The display device can be in a close proximity to the user.

For example, based on a calculation, the system can transmit a promotion notification 236 of “Product A” to the user 226's user device. As another example, the user 224 can get a promotion notification 234 regarding “Product B” on her user device. In some embodiments, the notifications 234 and 236 can be presented through software application on the user device. The users 224 and 225 can interact with the system through the software, such as asking for more product information, sending the system instructions, etc. The notifications 234 and 236 can also be presented on the user devices via a function of the user device operating system, such as a text, a phone call, etc.

The user device of the user 222 can receive more than one notification from the system. The system can determine an order of priority of the notifications to be sent to the user 222 based on the one or more decision rules as described with reference to FIG. 1. As users 222, 224, and 226 walk out of the beacon engagement session coverage area 200, their user devices cannot capture signals from the beacon device 202 and the beacon engagement session between the system and the user device terminates. Also, as new users walk into the beacon coverage area 200, the system can establish new beacon engagement sessions between user devices of the new users and the beacon device.

### Example Flowchart of a Beacon Engagement Session

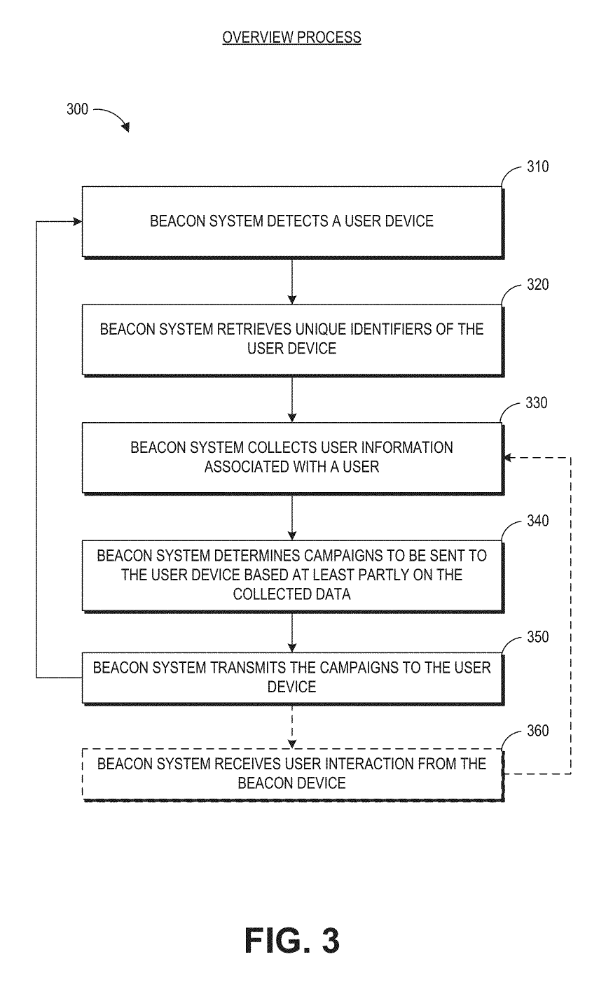

FIG. 3 illustrates a process flow diagram 300 of an example of a method for transmitting content to a user device via the enhanced mobile device beacon system. At block 310, the beacon system detects a user device via a beacon device. The beacon device can transmit a signal to the user device. As the user device captures the signal and a beacon engagement session begins, the system can establish a connection with the user device.

At block 320, the system can retrieve one or more unique identifiers of the user device. The unique identifiers can help the system to identify a user associated with the user device without identifying the user. Further, the system can collect user information during the session at block 330. The user information can contain attributes measurements, beacon engagement data, consumer demographic metrics and other information associated with the user. The system can store or update the collected user information in the user's profile.

At block 340, the system can determine one or more campaigns to be sent to the user device based at least partly on a computation of the collected user information. The determination can also be made based at least partly on a computation of the user information stored in the user database. If the system determines one or more campaigns to be sent to the user device, the system can determine an order of priority of the campaigns to be sent to the user device based on one or more decision rules.

At block 350, the system can transmit the one or more campaigns to the user device. In some embodiments, the system can transmit one or more notifications associated with the campaigns to the user device. The user devices can receive the notifications through system function of the user device such as a text or a phone call. The user device can also receive the notification via certain software such as a web browser. In some embodiments, the system can also display the one or more campaigns on a display device. The display device can be in a close proximity to the user.

At block 360, as the system transmits the one or more campaigns to the user device, the user can interact with the system through a system function of the user device, such as replying to a text message, etc. The user can also interact with the system via the software. The system can collect updated user information and determine new campaigns to be sent to the user device based on the interaction.

### Example Flowchart of a Beacon Engagement Session

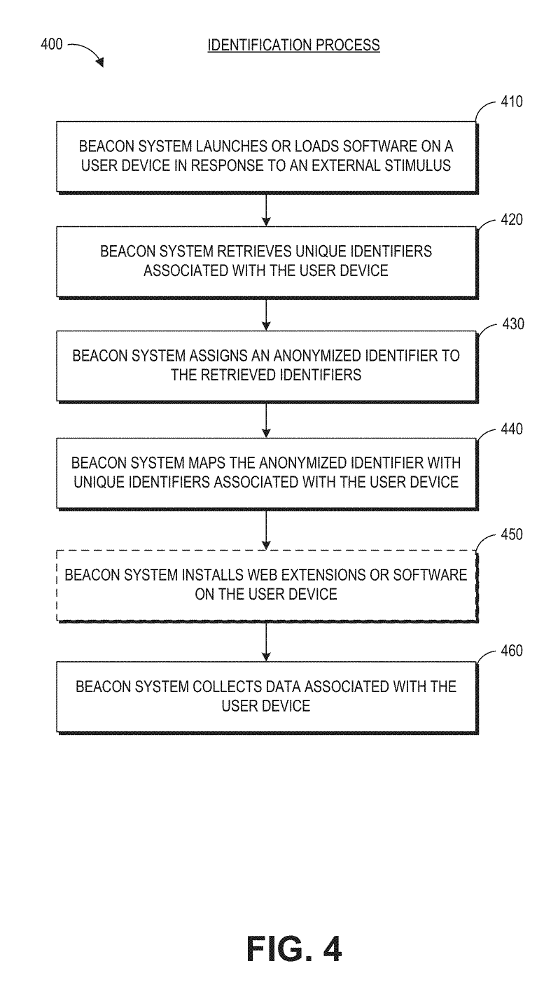

FIG. 4 illustrates a process flow diagram 400 of an example of a method for identifying a user via the enhanced mobile device beacon system. At block 410, as the system establishes a connection with a user device, the system can launch or load software on the user device in response to an external stimulus. The external stimulus can be signals a beacon device transmits. For example, the beacon device can transmit a URL signal. Upon capturing the URL signal, the user device can launch a web browser to access the information associated with the URL signal.

At block 420, the system can retrieve one or more unique identifiers associated with the user device. As described with reference to FIG.1, the unique identifiers can be any LAN identifiers. The unique identifiers can also be any WAN identifiers. The unique identifiers can help the system to identify a user associated with the user device. The system, at block 440, can analyze user information and assign an anonymized identifier to the unique identifiers of the user device. As a result, unique identifiers associated with a single user device are mapped with an anonymized identifier.

In some embodiments, optionally the system can install web extensions or software on the user device at block 450. The web extensions or software can be used by the system to communicate with the user device. The system can then collect user information associated with the user device at block 460. The system can then use the collected user information to determine one or more campaigns to be sent to the user device as described with reference to FIGS. 1 to 3.

### Example Flowchart of a Beacon Engagement Session

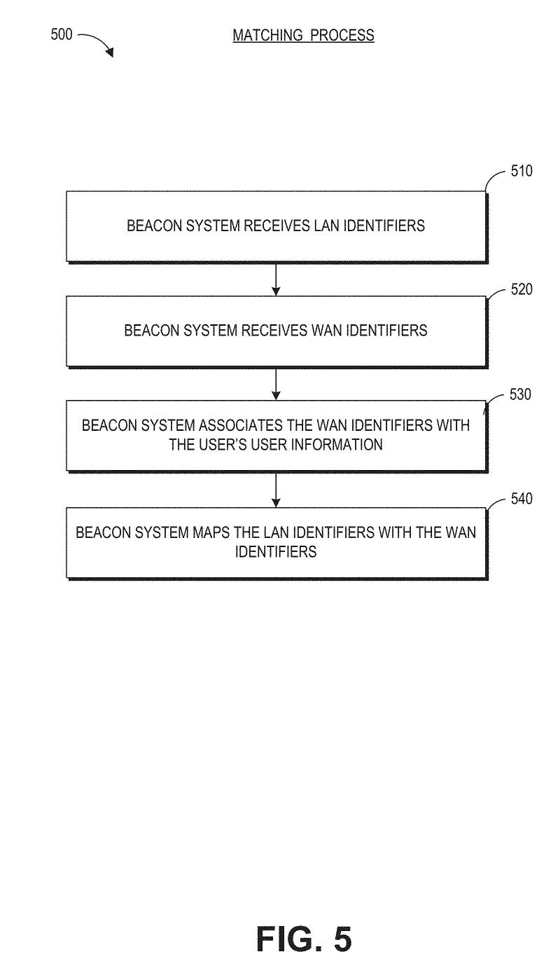

FIG. 5 illustrates a process flow diagram 500 of an example of a method for mapping identifiers of a user device. As the system communicates with a user device, the system can retrieve one or more unique identifiers associated with the user device at blocks 510 and 520. As described with reference to FIG.1, the unique identifiers can be any LAN identifiers. The LAN identifiers can be MAC address, Bluetooth ID, etc. The unique identifiers can also be any WAN identifiers. The WAN identifiers can be cookies, browsing history, etc. The system, at block 530, can associate the WAN and LAN identifiers with the collected user information, such as household information, individual attributes, etc. The system can then map the LAN identifiers and the WAN identifiers based at least partly on the user information at block 540. In some embodiments, the system can assign an anonymized identifier for a user. The system can then, based on the user information collected associated with the unique identifiers, map the LAN identifiers and the WAN identifiers with the anonymized identifier.

### Example of Multiple Beacon Engagement Sessions

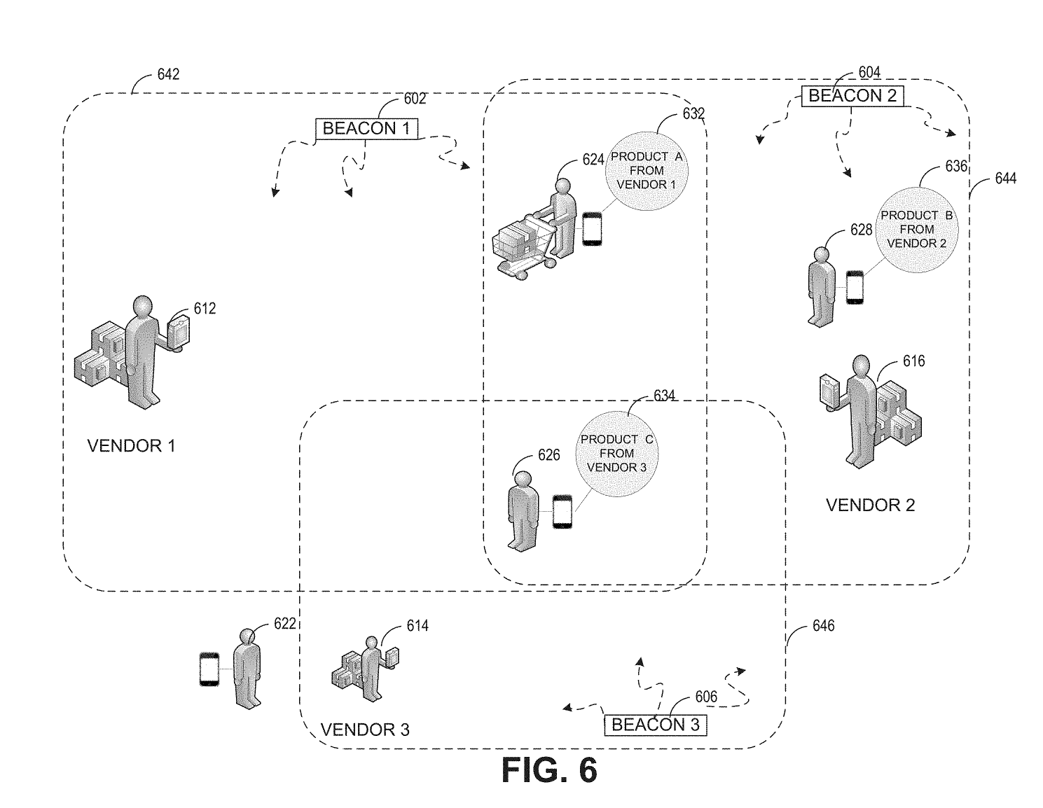

FIG. 6 illustrates an example of determining content to be sent to user devices in multiple beacon sessions via the enhanced mobile device beacon system. There are three beacon devices 602, 604, and 606 in FIG. 6. The beacons devices 602, 604, and 606 have coverage areas 642, 644, and 646, respectively. Their coverage areas, 642, 644 and 646 overlap with each other as shown in FIG. 6. The beacon devices 602, 604, and 606 belong to system users 612, 614, and 616, respectively. The beacon devices can be placed physically close to each other. For example, the beacon devices can be placed in a mall and three system users 612, 614, and 616 operate different stores in the mall. As people walk around in the mall, the beacon devices 602, 604, and 606 can establish beacon engagement sessions with user devices in their beacon coverage areas. As their coverage areas overlap with each other, more than one beacon devices can communicate with a user device. In FIG. 6, a user 624 is in the beacon coverage areas of the beacon devices 602 and 604. As another example, a user 626 is in coverage areas of all three beacon devices. A user 636 is in the coverage area of the beacon device 626. A user 622 is not in any coverage area.

As the system establishes connections with a user device, the system can collect unique identifiers or user information associated with the user device. The system can determine one or more campaigns to be sent to the user device. In some embodiments, the campaigns can be beacon specific campaigns. For example, campaigns regarding product A can be transmitted to a user device if the user device is within the beacon coverage 642 of the beacon device 602. The system can determine one or more campaigns to be sent to the user device based at least partly on data associated with the user device in the user database, data in the campaign database, the beacon device, etc. The system can then determine a priority of notifications to be sent to the user device. The notification can contain information about the campaigns. The system can determine the priority based on the one or more decision rules as described with reference to FIG. 1.

In FIG. 6, the user device of the user 628 has established connections with the beacon device 604, the system can determine one or more campaigns to be sent to the user device. The user device of the user 624 has established connections with the beacon device 602 and the beacon device 604. The two beacon devices 602 and 604 can collect user information and unique identifiers of the user device of the user 624. The system can then, based on the unique identifiers and user information, determines one or more campaigns to be sent to the user device. If the system determines a campaign “product A from vendor 1” to be sent to the user device, the system can send the user device the campaign via a notification as shown in FIG. 6.

As another example, the user device of the user 626 has established connections with the beacon device 602 and the beacon device 606. The two beacon devices 602 and 606 can collect user information and unique identifiers from the user device. The system then, based on the unique identifiers and user information, determines more than one campaigns to be sent to the user device. The campaigns can be “product A from vendor 1” to be transmitted via the beacon device 602 and “product B from vendor 2” to be transmitted via the beacon device 606. The system can then determine an order of priority of the campaigns to be sent to the user device based on one or more decision rules. For example, if a decision rule that prioritizes notifications based on the distance between the user device and the beacon device is used by the system, the system can determine that it should send the campaign “product B from vendor 2” via the beacon device 606 to the user device first as the user device is closer to the beacon 606 than to the beacon device 602.

### Example Flowchart of Multiple Beacon Engagement Sessions

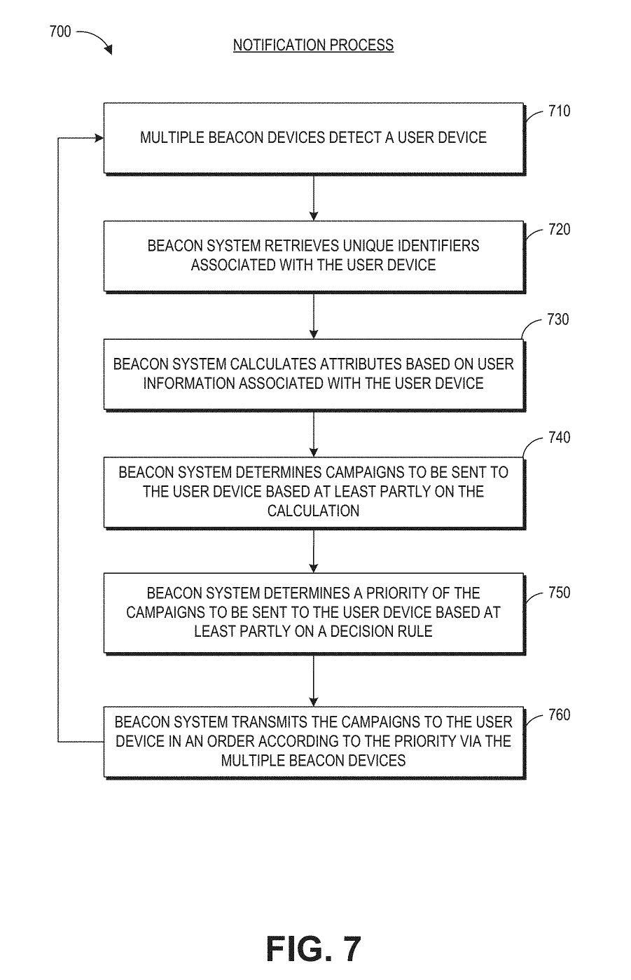

FIG. 7 illustrates a process flow diagram 700 of an example of a method for determining content to be sent to a user device in multiple beacon sessions via the enhanced mobile device beacon system. At block 710, multiple beacon devices detect a user device in their beacon engagement session coverage areas by transmitting signals that can be captured by the user device. The system can establish connections with the user device as the user device captures the signals. The system can then retrieve unique identifiers of the user device at block 720. The system can also collect user information associated with the user device.

At blocks 730 and 740, based at least partly on the collected user information, data in the user database, campaign database, the system can calculate attributes to determine campaigns to be sent to the user device. The campaigns can be beacon specific campaigns that can only be transmitted to a user device if the user device is engaged in a session with a specific beacon device.

The system, at block 730 and 740, can compute attributes in the user information, either collected by the beacon device, stored in the system, or both, based on the campaign criteria to determine one or more targeted campaigns. The attributes can be obtained by the beacon device as the beacon device communicates with the user device, where the beacon device can collect user information of the user. The user information can include attributes that can be used to identify the user. The user information can also include non-personal identifiable attributes. The attributes can be associated with various aspects of a user, including but not limited to, demographic attributes, psychographic attributes, location attributes. The system can make the determination based on the computation of some or all of the attributes associated with the user.

The system, in some embodiments, can determine the one or more campaigns based on personal identifiable information alone. The determination can be based on computation of location attributes where the location attributes are collected via the beacon device. For example, based on the location attributes associated with the user, the current location, past locations the user has been visited, the system can determine the one or more targeted campaigns to be sent to the user device. The targeted campaigns can be those campaigns that interest the user. This way, the system can make a campaign recommendation without knowing the identity of the user.

At block 750, the system can determine an order of priority of the campaigns to be sent to the user device based on one or more decision rules. The decision rules are described in details with reference to FIG. 1. The system can then transmit the campaigns to the user device in based on the order of priority. The system can transmit the campaigns via the beacon devices. In some embodiments, the system can transmit the campaigns to the user devices directly.

FIG. 8 illustrates another example of computing environment of the enhanced mobile device beacon system. The example computing environment in FIG. 8 is similar to the example in FIG. 1. Additionally, the computing environment in FIG. 8 includes display devices A 810a to N 810n. In some embodiments, the display devices can be devices that are connected to the beacon device A 140a, the user device A 110a to N 110n, the content management system 120 via the network 102. The display devices A 810a to N 810n can be a TV, a billboard, or any other devices that display campaigns or other information to users. The display devices A 810a to N 810n can be physically located close to the beacon device A 140a during a beacon engagement session as the display devices A 810a to N 810n can display campaigns to the users nearby. In some embodiments, the display devices A 810a to N 810n can be incorporated in a single device with the content management system 120 and the beacon device A 140a.

Example of a Computing Environment with Display Devices

In the example of FIG. 8, as the system establishes connections with the user device A 110a via the beacon device A 140a, the system can calculate attributes associated with the user device A 110a and determine one or more campaigns to be sent to the user device A 110a. In some embodiments, as the system calculates attributes associated with each user device, the system can also determine one or more campaigns to be displayed on the display device A 810a. The system can determine the campaigns to be displayed based on calculating attributes associated with the user device A 110a. The campaign optimization system 124 can also analyze and predict one or more campaigns with better outcomes. The system can then transmit the campaigns to the display device A 810a. The display device A 810a can then display the campaigns to the users.

In some embodiments, as the display device A 810a displays the campaigns to the user. The system can send a notification to the user device A 110a. The user can interact with the system via the user device A 110a as it receives the notification. Based on the user's interaction, the system can update campaigns to be displayed on the display device A 810a. For example, as the display device A 810a displays a campaign of motorcycles, the users can communicate with the system requesting new information regarding the campaign. The system can then, based at least partly on the interaction and calculation of updated attributes, determine one or more new campaigns to be displayed on the display device A 810a. As another example, the system can be used as a poll system. The system can instruct the display device A 810a to display poll questions. Users can answer the questions via their devices.

Example of a Beacon Engagement Session with a Display Device

FIG. 9 illustrates an example of determining content to be displayed to users via the enhanced mobile device beacon system. The display device 910 in the FIG. 9 can have one or more beacon devices incorporated within. The display device 910 can also be connected to one or more remote beacon devices via a wired or wireless network. The display device 910 can be a billboard in a mall and the billboard can be connected to more than one beacon devices in the mall. As another example, the display device 910 can be a TV in a store. The display device 910 can also be a billboard close to a freeway. Users 922, 924, 926, 928 and 930 can each have one or more user devices on them.

The system can establish connections with the user devices via the beacon devices as the users pass by the display device 910 with a beacon coverage area 902. The system can then retrieve unique identifiers of the user devices. User information can be collected by the system as the beacon engagement session continues. The system can calculate attributes and determine one or more campaigns to be displayed on the display device 910.

The system can compute attributes in user information, either collected by the beacon device, stored in the system, or both, based on the campaign criteria to determine one or more targeted campaigns. The attributes can be obtained by the beacon device as the beacon device communicates with the user device, where the beacon device can collect user information of the user. The user information can include attributes that can be used to identify the user.

The user information can also include non-personal identifiable attributes. The attributes can be associated with various aspects of a user, including but not limited to, demographic attributes, psychographic attributes, location attributes. The system can make the determination based on the computation of some or all of the attributes associated with the user.

The system, in some embodiments, can determine the one or more campaigns based on personal identifiable information alone. The determination can be based on computation of location attributes where the location attributes are collected via the beacon device. For example, based on the location attributes associated with the user, the current location, past locations the user has been visited, the system can determine the one or more targeted campaigns to be sent to the user device. The targeted campaigns can be those campaigns that interest the user. This way, the system can make a campaign recommendation without knowing the identity of the user.

In some embodiments, as the system displays campaigns on the display device, the system can send one or more notifications to the user devices. The users 922, 924, 926, 928 and 930 can interact with the system via their user devices.

The system can establish new connections with new user devices as new users walk into the coverage area 902 of the beacon devices. The system can also terminate existing connections with the connected user devices as the users leave the coverage area 902. The system can update user information associated with the connected user devices periodically. The system can determine new campaign to be displayed on the display device 910 based on the updated user information.

If the system determines to display two or more campaigns on the display device 910, the system can then determine an order of priority of the campaigns to be displayed based one or more decision rules. The decisions rules are described in details with reference to FIG. 1.

Example Flowchart of a Beacon Engagement Session with a Display Device

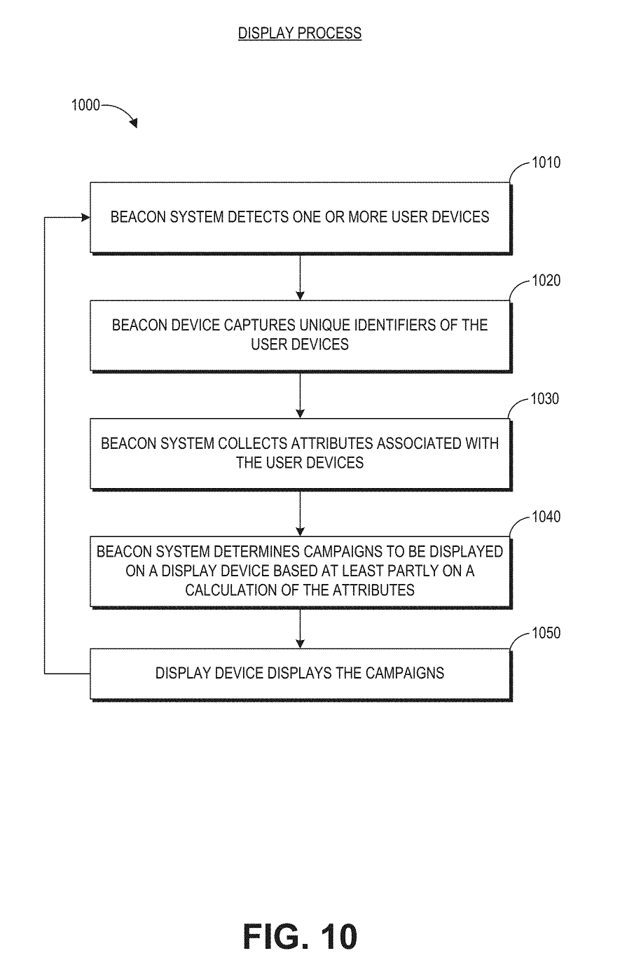

FIG. 10 illustrates a process flow diagram 1000 of an example of determining content to be displayed to users via the enhanced mobile device beacon system. At block 1010, the system detects one or more user devices via one or more beacon devices. The system can establish connections with the user devices via the beacon devices. Upon establishing connections, the system can retrieve unique identifiers of the user devices and user information associated with the user devices at block 1020.

The system can also collect user information associated with the user devices at 1030. The user information can contain attributes of the users. The attributes can be associated with personal information about the user. The personal information can include attribution measurements, beacon engagement, consumer demographic metrics associated with the user devices, etc. The system can also update user information in the user's profile in the system. As the system collects user information, the system can update the user profile in the system.

At block 1040, the system can determine one or more campaigns to be displayed on a display device. The determination is based at least partly on a calculation of the attributes. If the system determines two or more campaigns to be displayed, the system can then determine an order of priority of the campaigns to be displayed based on one or more decision rules. The system can then display the campaigns on the display device at block 1050. As the system establishes connections with new user devices or terminates connections with existing user devices, the system can go back to block 1010.

Example of a Beacon Engagement Session with Multiple Display Devices

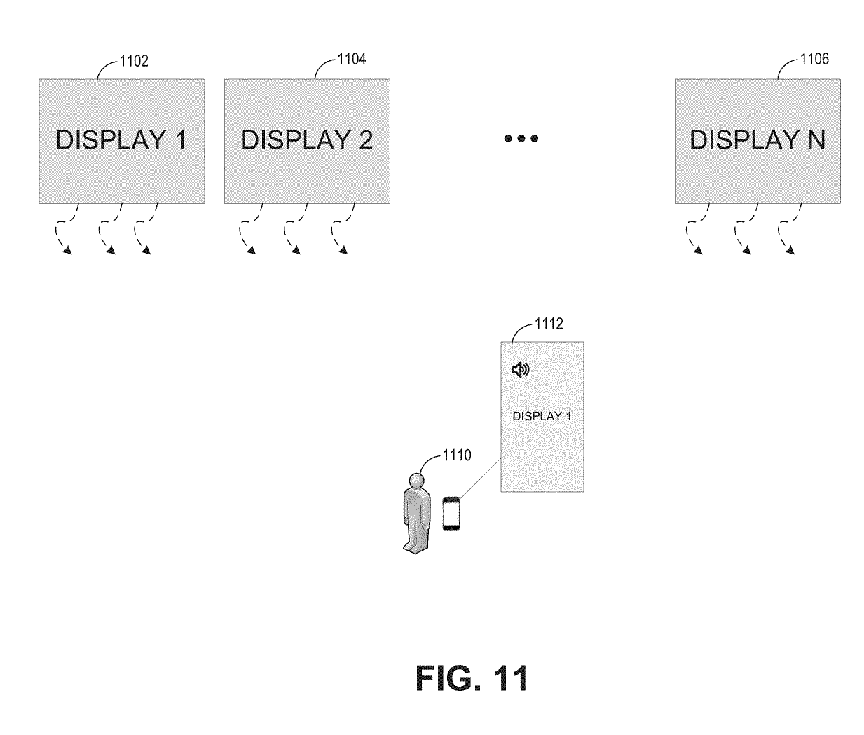

FIG. 11 illustrates an example of interaction between user devices and multiple beacon sessions via the enhanced mobile device beacon system. In the example of FIG. 11, there are more than one display device: display device 1102, 1104 . . . and 1106. The display devices can each have an enhanced beacon system incorporated within. In some embodiments, the display devices can be connected to one or more enhanced beacon systems via a wired or wireless network. The display devices can display campaigns stored and determined by the system. In some embodiments, the campaigns can be transmitted from a third-party system. The campaign can also be a live stream, such as TV, satellite, etc.

In the example of FIG. 11, the system can determine two or more campaigns to be displayed on the multiple display devices. The display devices can display the campaigns as instructed by the system. The display devices, in one example, can be placed in a single location, such as a bar. The display devices can display multiple targeted campaigns to users in the bar based on the computation of attributes associated with all users in the bar.

As another example, the display devices 1102 through 1106, each with a beacon device incorporated within, can be placed in different locations, such as various hotel rooms. If the user 1110 stays in a room where the display device 1102 is located, the system can determine one or more campaigns to be displayed on the display device 1102 based on the computation of attributes associated with the user 1110. In some embodiments, each TV in a room can incorporate or be connected to a beacon device. For example, display device, TV 1102 can be connected to a beacon device. The beacon device of the TV 1102 can have a beacon coverage area of a hotel room. The beacon device for the TV 1102 can broadcast a signal that is unique to the TV 1102. When the unique signal is captured by the user device of the user 1110, the system can establish connections between the TV 1102 and the user device. The user 1110 can use his device as a remote control to control the contents or campaigns being displayed on the TV 1102.

In some embodiments, each display device can include a STB identifier, which is an identifier unique to the display device. The STB identifier can be captured by a user device as well. As the STB identifier is captured by user devices, the system can identified the user devices in the same room as the display device. The system can limit the transmission of the campaigns or contents to the identified display devices. This can improve the accuracy of the location information collected by the system.

As the system establishes connections with the user device of a user 1110, the system can transmit remote control options to the user device, such as campaign viewing options. The campaign viewing options can include a choice of the one or more campaigns to be displayed on the display devices 1102 through 1106. The campaigns can be the same ones as those being displayed on the display devices 1102 through 1106. The user can choose which campaign he wishes to view. As another example of remote control options, the user can also choose which display device he wishes to view the selected campaign. The user can also indicate that he wishes to view the selected campaign on his device. The interaction can be made with the help of software installed on the user device or as one of the system functions of the user device.

As the user makes his choice, the selected campaign can be displayed on the user device or a selected display device. The user device can indicate what campaign the user is viewing via the software. The software can include a visual indicator that can remind the user that enhanced audio or video services are available via the user device. For example, the user may wish to receive only listen to an audio or view a video of a campaign on his device. He can instruct the system to transmit only audio or video data to his device. He can also instruct the beacon system to adjust the volume of the campaign. He can also instruct the system to display a different campaign from a different display device on his user device.

Example Flowchart of a Beacon Engagement Session with a Display Device

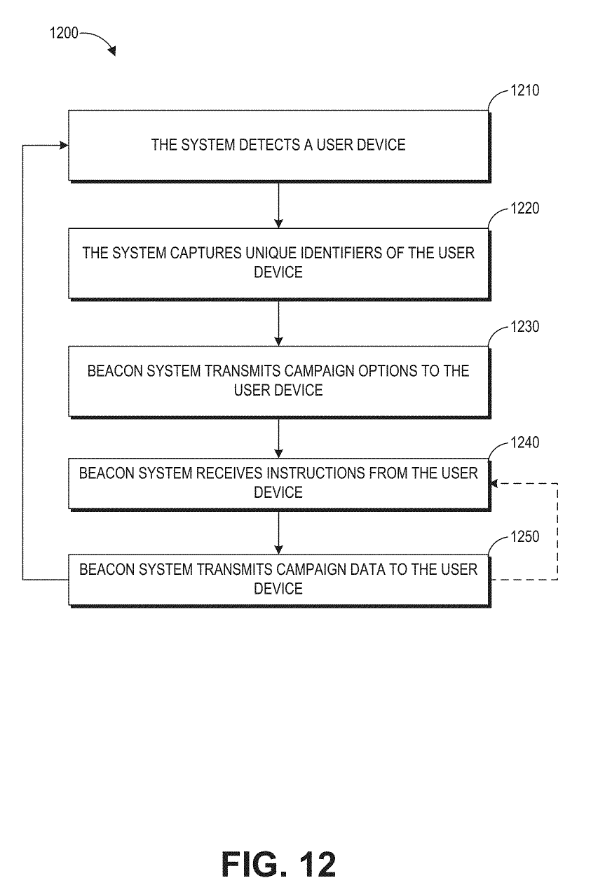

FIG. 12 illustrates a process 1200 of an example of interaction between user devices and multiple beacon sessions via the enhanced mobile device beacon system. At block 1210, the system detects a user device in the coverage area of a beacon device. As the system establishes connections with the user device, the system can capture unique identifiers of the user device at 1220. The system can also collect user information associated with the user device. In some embodiments, the system can determine one or more campaigns to be displayed on one or more display devices. The campaigns can be campaigns stored in the system, campaigns from a third-party system, live streams, etc. The display devices can display the campaigns as instructed by the system.

At block 1230, the system can transmit a viewing option of the campaigns to the user device. The user can send an instruction to the system. The instruction can indicate which campaign he wishes to view on his user device. As the system receives the instruction at block 1240, the system can transmit campaign data to the user device at block 1250. In some embodiments, the user can send further instructions to the system. For example, the user can instruct the system that he wishes to view another campaign displayed on another display device. As another example, the user can instruct the system that he only wishes to receive audio data of the campaign.

### Terms

In the above description of the present disclosure, the term “demographics” is used frequently. While this term is sometimes used within the media industry to describe a finite set of commonly used population characterization criteria (e.g., age, income, ethnicity, and so on), the term as used herein further encompasses the broadest possible sense of any characteristics of human populations and population segments (e.g., used to identify consumer markets). This includes criteria traditionally called psychographics, as well as historical purchase behaviors or online we browsing behaviors, for example. The term “determine” can also be interpreted to mean “estimate.”

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “module” or “engine” refers broadly to general or specific-purpose hardware, software, or firmware (or any combination thereof) components. Modules and engines are typically functional components that can generate useful data or other output using specified input(s). A module or engine may or may not be self-contained. Depending upon implementation-specific or other considerations, the modules or engines may be centralized or functionally distributed. An application program (also called an “application”) may include one or more modules and/or engines, or a module and/or engine can include one or more application programs.

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network or a wide area network, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification. Also, the term “or” is used in its inclusive sense (and not in its exclusive sense) so that when used, for example, to connect a list of elements, the term “or” means one, some, or all of the elements in the list.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the disclosures described herein may be embodied within a form that does not provide all of the features and benefits set forth herein, as some features may be used or practiced separately from others. The scope of certain disclosures disclosed herein is indicated by the appended claims rather than by the foregoing description. All changes which come within the meaning and range of equivalency of the claims are to be embraced within their scope.

1. An enhanced beacon system which detects attributes of a user based on information obtained from or about a user device, the enhanced beacon system comprising:
a data store including one or more databases and one or more computer storage media, the data store including
a first database configured to store user information of a plurality of users; and
a second database configured to store campaign information of a plurality of campaigns; and
a server configured to
communicate with a beacon device, wherein the beacon device
retrieves a first unique identifier transmitted wirelessly from the user device, wherein the user device being within a threshold distance of the beacon device;
receive the first identifier from the beacon device, wherein the first identifier a is used to identify user information associated with the user in the first database;
determine a first campaign of interest for the user based at least partly on the user information and target criteria of the first campaign, wherein the first campaign and the target criteria of the first campaign are stored in the second database; and
provide the user with the first campaign.

2. The system of claim 1, wherein the server is further configured to:
transmit the first campaign to the user device;
receive an outcome from the user device regarding the first campaign;
store the first outcome as part of the user information in the user profile and as part of campaign information in the campaign database;
refine the first campaign based at least partly on the outcome; and
update the refined first campaign in the second database.

3. The system of claim 1, wherein the server is further configured to display the first campaign on a display device, wherein the display device is in close proximity to the user device.

4. The system of claim 3, wherein the server transmits the first campaign to the user device based on transmissions from the beacon device.

5. The system of claim 1, wherein the server is further configured to estimate a second campaign of interest for the user based at least partly on the user information and target criteria of the second campaign, wherein the second campaign and the target criteria of the second campaign are stored in the second database.

6. The system of claim 5, wherein the server is further configured to determine an order of priority of the first campaign and the second campaign to be provided to the user based on one or more decision rules.

7. The system of claim 6, wherein the server is further configured to provide the user with the first campaign and the second campaign based on the determined order of priority.

8. The system of claim 1, wherein the server is further configured to assign an anonymized identifier to the user profile and map the first unique identifier with the anonymized identifier.

9. The system of claim 1, wherein the server is further configured to receive a second unique identifier of the user device, wherein the second unique identifier is retrieved by the beacon device.

10. The system of claim 9, wherein the server is further configured to map the first unique identifier and the second identifier based at least partly on their associations with the user device.

11. The system of claim 1, wherein the user information includes at least attributes associated with physical movements of the user.

12. (canceled)

13. The system of claim 11, wherein the user information further includes demographic information, psychographic information, location information, distance information or any other personal information associated with the user.

14. A database processing method executed on a server to retrieve and store data in one or more databases which detects attributes of a user based on information obtained from or about a user device, the database processing method comprising:
storing user information of a plurality of users in a first database;
storing campaign information of a plurality of campaigns in a second database;
communicating with a beacon device, wherein the beacon device
retrieves a first unique identifier transmitted wirelessly from the user device, wherein the user device is within a threshold distance of the beacon device;
receiving the user information and the first identifier from the beacon device, wherein the user information populating a user profile associated with the user in the first database;
estimating a first campaign of interest for the user based at least partly on the user information and target criteria of the first campaign, wherein the first campaign and the target criteria of the first campaign are stored in the second database; and
providing the user with the first campaign.

15. The method of claim 14 further comprising:
transmitting the first campaign to the user device;
receiving an outcome from the user device regarding the first campaign;
storing the first outcome as part of the user information in the user profile and as part of campaign information in the campaign database;
refining the first campaign based at least partly on the outcome; and
updating the refined first campaign in the second database.

16. The method of claim 14 further comprising displaying the first campaign on a display device, wherein the display device is in close proximity to the user device.

17. The method of claim 15, where the user device receives the first campaign based on transmissions from the beacon device.

18. The method of claim 14 further comprising estimating a second campaign of interest for the user based at least party on the user information and target criteria of the second campaign, wherein the second campaign and the target criteria of the second campaign are stored in the second database.

19. The method of claim 18 further comprising determining an order of priority of the first campaign and the second campaign to be provided to the user based on one or more decision rules.

20. The method of claim 19 further comprising providing the user with the first campaign and the second campaign based on the determined order of priority.

21. (canceled)

22. The method of claim 14 further comprising retrieved from the beacon device a second unique identifier of the user device, wherein the second unique identifier is retrieved by the beacon device.

23. The method of claim 22 further comprising mapping the first unique identifier and the second identifier based at least partly on their associations with the user device.

24. The method of claim 14, wherein the user information includes at least attributes associated with physical movements of the user.

25. The method of claim 14, wherein the attributes associated with physical movements contain no personal identifiable information.

26. The method of claim 24, wherein the user information further includes demographic information, psychographic information, location information, distance information or any other personal information associated with the user.

27. A beacon device which detects attributes of a user device based on information obtained from or about the user device, the beacon device is configured to:
retrieve a first unique identifier transmitted wirelessly from the user device, wherein the user device being within a threshold distance of the beacon device;
measure the signal strength of the wireless transmission of the first unique identifier, wherein the measurement is made from one antenna connected to the beacon device;
encrypt first unique identifier; and
transmit the collected encrypted first unique identifier and signal strength to a server.

28. The beacon device of claim 27 is further configured to:
measure the signal strength of the wireless transmission of the first unique identifier, wherein the measurement is made from a second antenna connected to the beacon device; and
measure the signal strength of the wireless transmission of the first unique identifier, wherein the measurement is made from a third antenna connected to the beacon device; and
transmit the collected second and third signal strengths to a server.

29. The beacon device of claim 27 is further configured to wirelessly transmit a unique identifier of the beacon device to the user device using Bluetooth standards.

30. (canceled)

31. (canceled)

32. (canceled)

33. (canceled)

34. (canceled)

35. (canceled)

36. (canceled)

37. The system of claim 1, wherein the server is further configured to receive a second unique identifier of the user device, wherein the second unique identifier is sent by a wireless communications network.

38. The system of claim 37, wherein the server is further configured to map the first unique identifier and the second identifier based at least partly on their associations with the user device.
